(19) United States
(12) Patent Application Publication
(10) Pub. No.: US 2022/0295832 A1
(43) Pub. Date: Sep. 22, 2022

(54) GAS DISPENSING METHOD AND APPARATUS

(71) Applicant: TFB CONSULTING LTD, Mayfield, OH (US)

(72) Inventor: Thomas BELCHER, Mayfield, OH (US)

(73) Assignee: TFB CONSULTING LTD, Mayfield, OH (US)

(21) Appl. No.: 17/636,783

(22) PCT Filed: Aug. 19, 2019
(86) PCT No.: PCT/US19/47111

§ 371 Date: Feb. 18, 2022

(51) Int. Cl. A23L 2/54; B01F 23/2361; B01F 23/237

(52) U.S. Cl. CPC A23L 2/54; B01F 23/23611; B01F 23/237612; B01F 2101/17

(57) ABSTRACT

An apparatus and method are provided for dispensing gas to a fluid, such as a beverage, through a delivery system from a vessel containing the gas into another vessel containing the fluid.

Historically, wine decanting was a process to filter out sediment left in the wine bottle after aging, and mixing air into the wine to enhance its taste. As used here, decanting will be defined as a process to aerate or-more specifically, increase the dissolved oxygen concentration in wine or other liquids. In order for wine to reach its optimum drinking potential, typically one allows the wine to “breathe” which means expose the wine to air, preferably for a number of hours. Traditionally this has been done by uncorking a bottle and pouring the wine into another vessel which has a widened body so that a greater surface area of wine is exposed to the air. Exposure to air helps break up and dispel the concentrated gasses present in the wine which have been kept from exposure to air up until the point that the bottle is opened. The decanting process increases the dissolved oxygen level in the wine and is generally recognized to improve flavors and balancing on the palate by increasing depth and complexity of the wine's undertone flavors as well as softening harsh tannins and opening up its aromatics.

Once a bottle of wine, for example, has been opened continued exposure to air, specifically, oxygen can degrade over time any wine remaining in the bottle. One way to preserve the remaining wine is through a process of removing or displacing the air in contact with the remaining fluid by blanketing it with a heavier, inert gas, such as argon.

The taste, mouth feel and experience with other liquids, such as bourbons, whiskeys, scotch and others also can be improved, enhanced and/or altered by application of air, oxygen or other gasses.

The accompanying drawings, which are incorporated in and constitute a part of the specification, illustrate various example systems, methods, and so on that illustrates various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

### DESCRIPTION OF DRAWINGS

FIG. 1 is a perspective view of an example gas dispensing device.

FIG. 2 is a is an exploded view of an example gas dispensing device.

FIG. 3 is a detail of components of the gas dispensing device of FIG. 2.

FIG. 4 is a detail of components of the gas dispensing device of FIG. 2.

FIG. 5 is a perspective view of an exemplary key plate.

FIG. 6 is a cross-sectional view of part of an exemplary dispensing actuator assembly.

FIG. 7 is a top perspective view of a vessel adapter.

FIG. 8 is an exploded view of components of an example gas dispensing device.

FIG. 9 is a chart of experimental data.

### DETAILED DESCRIPTION

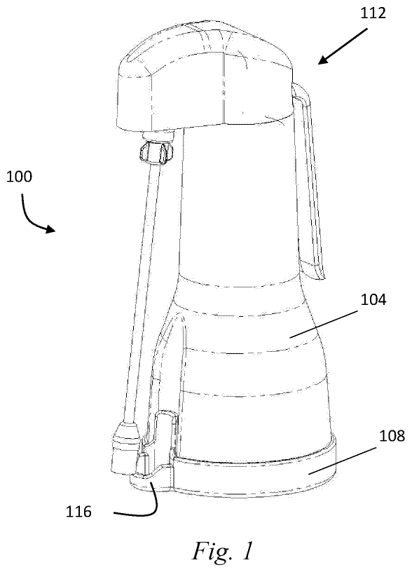

With reference now to FIG. 1 a hand-held device 100 includes a hand-held housing 104 including a bottom 108 and a dispensing actuator assembly 112. The bottom 108 can be formed integrally with the housing 104 or formed as a removable, resilient material such as rubber or plastic that closely fits over the bottom 108. Alternately, the bottom can include a resilient or more rigid material to be threaded or screwed onto the bottom of housing. The bottom can optionally include a drip receptacle 116 protruding slightly from the bottom. After use, the removable bottom may be removed and cleaned.

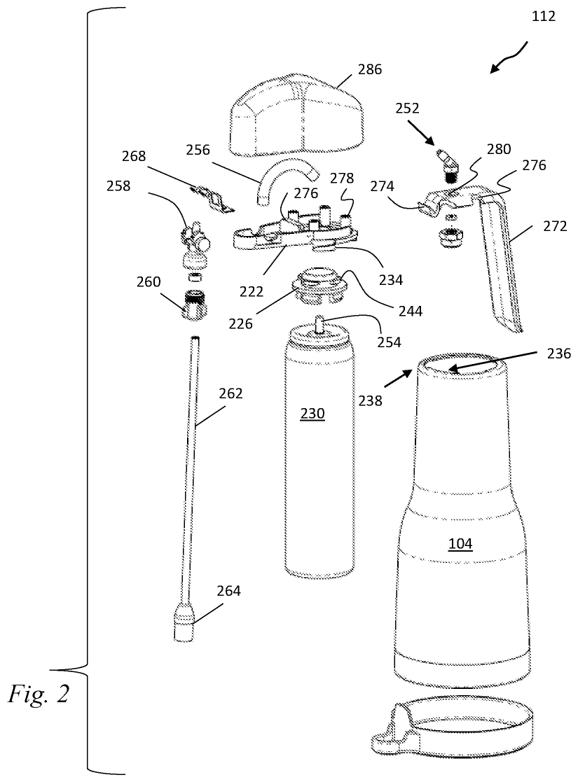

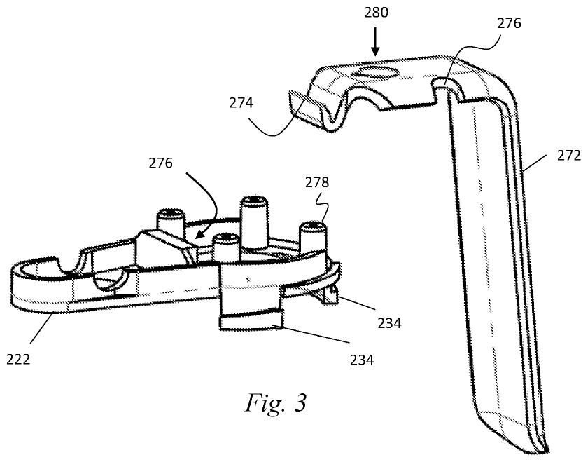

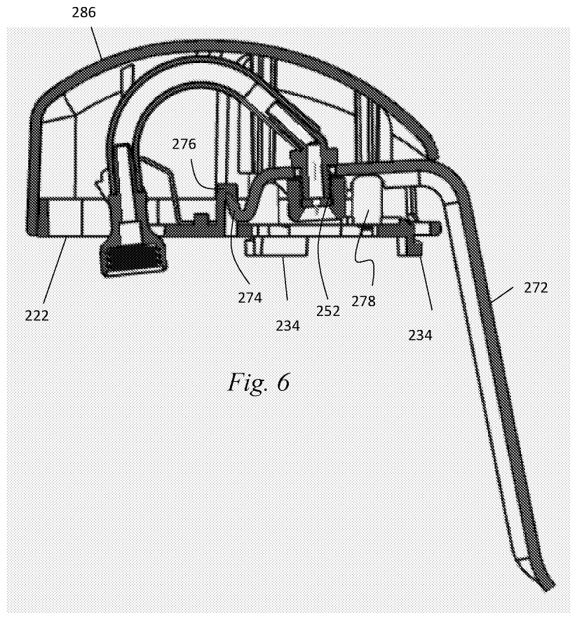

Referring now to FIGS. 2-6 the dispensing actuator assembly 112 includes a key plate 222 formed to engage with the housing 104 and with a vessel adapter 226 connected to a vessel 230 of pressurized gas. In one embodiment, the pressurized gas is oxygen when used to decant a liquid such as wine or spirits. In such use, the nozzle is typically placed in the liquid to be decanted. In another embodiment, the pressurized gas is argon when used to preserve wine or spirits by displacing oxygen. In such use, the nozzle is typically placed above liquid to be preserved. As illustrated, the key plate 222 includes housing engagement teeth 234 to engage with complementary inward facing teeth 236 on a top side 238 of the housing 104. Key plate 222 further includes vessel engagement teeth 504 (FIG. 5) to engage with complementary outward facing teeth 244 on the vessel adapter 226.

In alternate embodiments, a hand-held device can omit the housing 104 and bottom 108 and include actuator assembly and vessel.

In use, a user may align the outward facing teeth 244 on the vessel with the vessel engagement teeth 504 and rotate, preferably about a third or quarter turn to lock the vessel 230 onto the key plate 222. Similarly, a user may then insert the combined vessel 230 and dispensing actuator 112 into the top side 238 of the housing 104 aligning the housing engagement teeth 234 with the inward facing teeth 236 and rotate to lock the housing and the combined vessel and dispensing actuator together. The multi-functionality of the key plate 222 allows, among others, a common, rigid, connection point for both the housing 104 and the vessel 230 that obviates the need for internal, lateral support for the vessel inside the housing in contrast to the embodiment illustrated in FIGS. 13-15. Additionally, the vessel may be detached or disengaged from the key plate and other vessels of gas attached without the loss of gas contained within either of the vessels. In other words, depending on user need, different aerosol canisters can be quickly exchanged for different functionality, such as Oxygen for decanting a spirit, then Argon for preserving a bottle of wine, and then another gas, for example, Helium for application to a craft cocktail or mocktail or another function without losing the gas within each vessel so they can be used again.

Dispensing actuator assembly 112 further includes a valve actuator assembly 252 that aligns with and contacts a valve stem 254 on the vessel 230 when the vessel is in the position, where the valve stem 254 and the valve actuator assembly 252 form a path for gas travel from the vessel, that in turn includes tubing 256, swivel 258, nozzle connector 260, adapter tube 262 and nozzle 264. The illustrated components comprising the path for gas travel from vessel to nozzle are not strictly all required and select ones may be removed or substituted without altering the functionality. In embodiments, a spring clip 268 is included to hold the adapter tube 262 and nozzle 264 in either the retracted or extended position. A manual actuator lever 272 includes a hinge point 274 that engages and is retained in place with a corresponding lip 276 on the key plate 222. The manual actuator lever 272 includes guides 276 that cooperate with at least two posts 278 on the key plate. The manual actuator lever 272 further includes an access 280 that surrounds the valve actuator assembly 252 and, when the manual actuator lever 272 is squeezed, causes the valve actuator assembly 252 to operate the valve stem 254 allowing contents of the vessel 230 to travel to the nozzle 264.

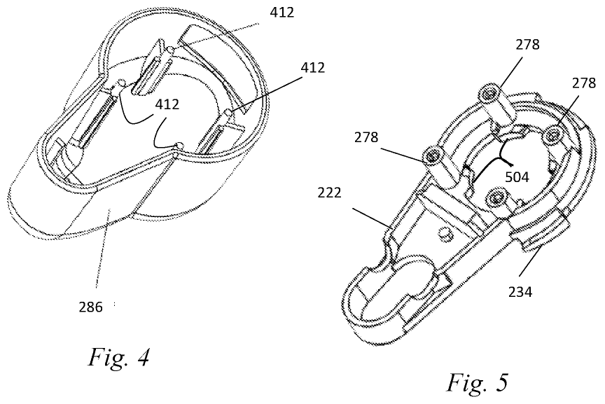

In assembled form, the dispensing actuator assembly 112 includes a cover 286 shaped to conform with the key plate 222 to enclose and hold the components of the assembly in place. In one embodiment, posts 278 mechanically connect with stakes 412 (FIG. 4) on an internal side of the cover 286. In FIGS. 4 and 5, the illustrated four stakes 412 mechanically connect with the corresponding four posts 278 such as by heat staking, thermal weld, screws, rivets, or the like.

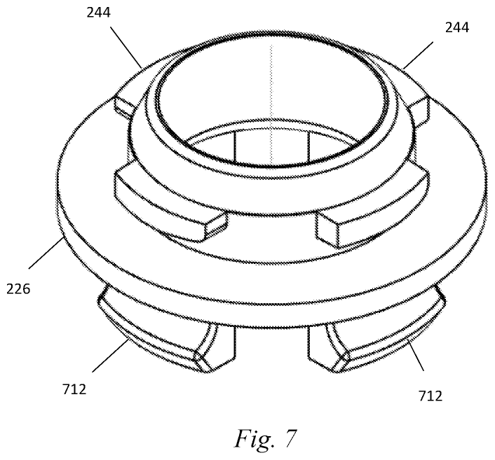

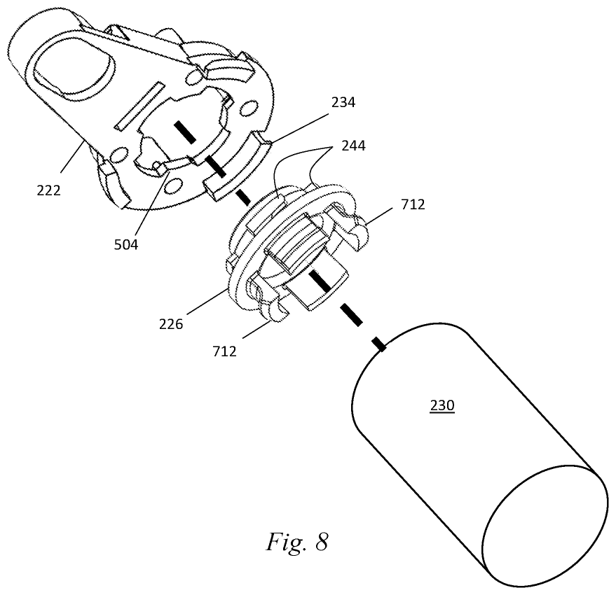

With reference now to FIGS. 7 and 8, vessel adapter 226 includes outward facing teeth 244 to rotatably engage with vessel engagement teeth 504 on the key plate 222. Vessel adapter 226 further includes fingers 2812 that are press fit and glued into place on the top of the vessel 230, otherwise known as the “valve cup.” Other attachment mechanisms are possible provided that the vessel adapter and vessel rotate together to permit engagement of the outward facing teeth 244 and the vessel engagement teeth 504. The four fingers illustrated engage the valve cup and are press fit into place following the application of an adhesive. This is one method of preventing the rotational slipping for the engagement and disengagement of the vessel loading.

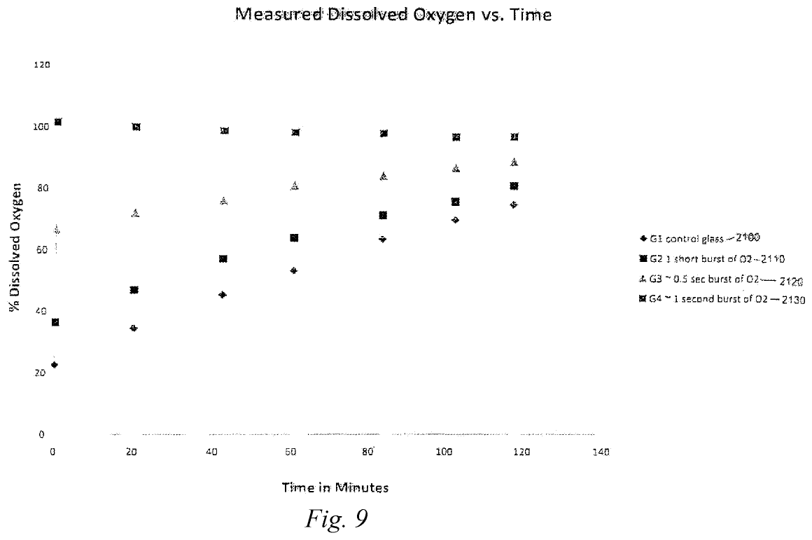

With reference to FIG. 9, a duration test was performed in which dissolved oxygen concentration over time in a control glass of wine is compared to dissolved oxygen concentration over time when infused with oxygen using a decanter for three different exposure durations. A bottle of Harvest Moon 2007 red blend Bordeaux style wine was opened and immediately poured into four different glasses. The first being the control glass (G1) in which no additional oxygen was added other than normal exposure to ambient air. The second glass (G2) was exposed to one short burst of oxygen with the decanter. The third glass (G3) and fourth glass (G4) were exposed to a 0.5 second burst of oxygen and a 1.0 second burst of oxygen from the decanter, respectively. The dissolved oxygen concentration was measured periodically over a two hour time period for all four glasses and the data are shown in Table 5 and FIG. 21. The initial dissolved oxygen concentration increases with increased O₂ infusion time. The wine exposed to a short burst (G2) from the decanter had 36.3% dissolved O₂, wine sample (G3) had 66.3% dissolved O₂, and a one second exposure (G4) yielded 101.4% dissolved oxygen. Even after two hours of exposure to ambient air, the control glass (G1) of wine does not reach the concentration of percent dissolved oxygen of any of the wines treated with the decanter.

TABLE 1

| Time | Control Glass | Short burst of O₂ | 0.5 sec O₂ | 1 sec of O₂ |
|---|---|---|---|---|
| (seconds) | (G1) | (G2) | (G3) | (G4) |
| 0 | 22.4% | 36.3% | 66.3% | 101.4% |
| 20 | 34.4% | 46.8% | 71.8% | 99.9% |
| 42 | 45.1% | 57% | 75.7% | 98.5% |
| 60 | 52.9% | 63.6% | 80.5% | 98% |
| 83 | 63.2% | 71% | 83.6% | 97.7% |
| 102 | 69.4% | 75.3% | 86.1% | 96.4% |
| 117 | 74.2% | 80.3% | 88.1% | 96.4% |

While the systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on provided herein. Additional advantages and modifications will readily appear to those skilled in the art. For example, while certain of the devices depicted and described herein employ pressurized oxygen, oxygen enriched air, air or a diaphragm or other air pump, the gas source may alternately include an oxygen generating or distributing device such as an oxygen generator or oxygen concentrator without loss of functionality. Therefore, the invention, in its broader aspects, is not limited to the specific details, the representative apparatus, and illustrative examples shown and described. Accordingly, departures may be made from such details without departing from the spirit or scope of the applicants' general inventive concept. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

As used herein, “connection” or “connected” means both directly, that is, without other intervening elements or components, and indirectly, that is, with another component or components arranged between the items identified or described as being connected. To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the claims (e.g., A or B) it is intended to mean “A or B or both”. When the applicants intend to indicate “only A or B but not both” then the term “only A or B but not both” will be employed. Similarly, when the applicants intend to indicate “one and only one” of A, B, or C, the applicants will employ the phrase “one and only one”. Thus, use of the term “or” herein is the inclusive, and not the exclusive use. See, Bryan A. Garner, A Dictionary of Modern Legal Usage 624 (2d. Ed. 1995).

1. A hand-held device to apply gas to a liquid, the device comprising:
a hand-held housing having an open bottom end and an opposed open top end, the top end including first inward facing teeth;
a resilient bottom sized to closely fit over the open bottom end and including drip receptacle; and
a dispensing actuator assembly including a key plate having first engagement teeth to engage the first inward facing teeth on the top end of the housing, the key plate further having second engagement teeth inward of the first engagement teeth where the second engagement teeth connect to a vessel adapter connected to a vessel of compressed gas and where the vessel adapter includes second outward facing teeth to rotatably engage with the second engagement teeth and hold the vessel in a position, the dispensing actuator assembly further including an actuator that aligns with a valve stem on the vessel when the vessel is in the position, where the valve stem and the actuator combine to comprise a path for gas travel from the vessel, the actuator connected to a manual actuating lever disposed external to and extending partially along the hand-held housing and user operated to urge the actuator to engage the valve stem and selectively release the compressed gas along the path.

2. The hand-held device as set forth in claim 1, further comprising an adapter tube having a first, proximal end and a second, distal end with a path for fluid communication there between, where the first, proximal end connects to the path for gas travel through a swivel to receive an amount of the pressurized gas.

3. The hand-held device as set forth in claim 2, further comprising a nozzle connected to the adapter tube at the second, distal end; wherein a user placing the nozzle into a container of liquid and operating the handle for at least 0.5 seconds causes the compressed gas to travel along the path and through the adapter and achieve dissolved oxygen content in the liquid of at least 50%.

4. The hand-held device as set forth in claim 1, further comprising a vessel containing pressurized gas.

5. The hand-held device as set forth in claim 4, where the pressurized gas comprises oxygen.

6. The hand-held device as set forth in claim 4, where the pressurized gas comprises argon.

7. The hand-held device as set forth in claim 1, where the liquid comprises wine.

8. The hand-held device as set forth in claim 1, where the liquid comprises alcohol.

9. The hand-held device as set forth in claim 1, where the liquid comprises spirits.

10. The hand-held device as set forth in claim 1, where the liquid comprises a non-alcoholic beverage.

11. A gas dispensing device comprising:
a vessel containing pressurized gas and including a valve stem selectively establishing a path for gas to pass from the vessel, and including a vessel adapter connected to a top side of the vessel and surrounding the valve stem where the vessel adapter includes engagement teeth extending radially outward from the vessel adapter;
a hand-held housing surrounding the vessel, the housing including a top end having engagement teeth extending radially inward from the housing;
a dispensing actuator assembly including a key plate having first engagement teeth to engage the engagement teeth extending radially inward from the housing, the key plate further having second engagement teeth extending radially inward where second engagement teeth rotatably connect to the engagement teeth extending radially outward from the vessel adapter, where the dispensing actuator further includes a lever to selectively depress the valve stem and permit passage of an amount of gas from the vessel;
an adapter having a first, proximal end and a second, distal end with a path for fluid communication there between, where the first, proximal end connects to the valve stem to receive the gas passing from the vessel; and
a nozzle in fluid communication with the adapter at the second, distal end of the adapter.

12. The gas dispensing device as set forth in claim 11, wherein the pressurized gas comprises oxygen, oxygen enriched air, air, or argon.

13. The gas dispensing device as set forth in claim 11, wherein the adapter is movable between a first stored position along a side of the hand-held housing and a second position angled away from the hand-held housing.

14. The gas dispensing device as set forth in claim 11, wherein the adapter comprises at least a pair of a telescoping components that may be extended to a user selected length.

15. The gas dispensing device as set forth in claim 11, wherein the adapter comprises at least a pair of a telescoping components that may be extended to a user selected position.

16. A method of adding a gas to a container of liquid, the method comprising:
(a) Aligning first engagement teeth on a key plate and first inward facing teeth on a top end of a housing;
(b) Rotating the housing with respect to the key plate, connecting the housing and key plate together;
(c) Aligning second engagement teeth on the key plate with outward facing teeth on a vessel adapter connected to a vessel of compressed gas;
(d) Rotating the vessel adapter with respect to the key plate, connecting the vessel and key plate together; and
(e) Operating a lever extending from the key plate and disposed external to the housing to depress a valve stem on the vessel so that compressed gas exits the vessel along a path of fluid communication from the valve stem to a nozzle disposed in the container of liquid.

17. The method as set forth in claim 16, where steps (c) and (d) precede steps (a) and (b).

18. The method as set forth in claim 16, further comprising placing the nozzle into an alcoholic beverage.

19. The method as set forth in claim 16, further comprising placing the nozzle into a non-alcoholic beverage.

20. The method as set forth in claim 16, further comprising placing the nozzle into the container and above the liquid.
